(19) United States
(12) Patent Application Publication
(10) Pub. No.: US 2005/0270721 A1
(43) Pub. Date: Dec. 8, 2005

(54) Tweezers with grounding wire

(75) Inventors: Takashi Okawa, Osaka-city (JP); Shigenobu Yamanaka, Osaka-city (JP); Hideki Utaki, Osaka-city (JP); Akio Harada, Osaka-city (JP)

Correspondence Address: KODA & ANDROLIA, 2029 CENTURY PARK EAST, SUITE 1140, LOS ANGELES, CA, 90067, US

(73) Assignee: Daiken Chemical Co., Ltd.

(21) Appl. No.: 11/204,716

(22) Filed: Aug. 16, 2005

(30) Foreign Application Priority Data
Feb. 17, 2004 (JP) 2004-40670

(51) Int. Cl. H02H 1/00

(52) U.S. Cl. 361/220

(57) ABSTRACT

There are proposed tweezers with grounding wire for grabbing a minute object containing an infinitesimal substance, which can discharge static electricity in the human body when it is used to grab a minute object, and which thus prevents the action of static electricity on the minute object and/or infinitesimal substance therein. The tweezers with grounding wire is constructed by connecting the grounding wire 2 for discharging the static electricity when a human operates the tweezers 1 The tweezers with grounding wire is particularly useful for handling a minute object 8 containing infinitesimal substance 7 of which shape is unrecognizable with naked eyes or an optical microscope. Since static electricity in the human body or in the object handled is discharged through the grounding wire 2 from the tweezers 1, the minute object 8 and the infinitesimal substance 7 to be handled are not subject to the action of static electricity, and thus are kept free from destruction or damage of static electricity.

### BACKGROUND OF THE INVENTION

1. Field of the Invention

The present invention relates to tweezers that are equipped with a grounding wire, and more specifically relates to tweezers with a grounding wire that is intended for holding a minute object containing infinitesimal substances, of which shapes are unrecognizable either by the naked eyes or by the use of an optical microscope.

2. Prior Art

Among conventional tweezers, for example, an operation apparatus that is disclosed in Japanese Patent Application Laid-Open (Kokai) No. 2003-126112, has been developed. As illustrated in FIG. 13, the holding portion of this apparatus is equipped with electrodes 111a and 111b as well as an insulated supporting member 119 that integrally supports the electrodes. The electrodes 111a and 111b are formed by a conducting material, having a shape that is bent at the center, and of which surface is coated with an insulating cover 112. Furthermore, the cover 112 is provided with an anti-slipping portion 115 from the center to the supporting portion 119.

In addition, the insulating cover 112 is not provided on the tip end portion 113 of the electrodes, whereby the tissues of a subject patient are touched for operation, nor inside the supporting portion 119. In other words, the conducting material is exposed at the tip end portion 113, while the supporting portion 119 per se serves the role of insulating cover. Furthermore, one electrode 111b is provided with a water-supplying pipe 116 that is used to introduce the physiological salt solution into the patient body when the apparatus is used as an electric surgical knife. One end of the water-supplying pipe 116 is provided with a water supplying opening 114 at the tip end portion 113, whereas the other end is connected to a water tank (not illustrated) via the supporting portion 119. Also, in the supporting portion 119, an insulating material (not illustrated) is provided to keep the electrodes 111a and 111b in an insulated condition.

The electrodes 111a and 111b are electrically connected to the main body of the operation apparatus through the connecting code 117. Furthermore, an LED 118 is provided on the supporting portion 119 as an illuminant. The LED 118 is also electrically connected to the main body of the operating apparatus through the connecting code 117. Grounding the electrodes 111a and 111b of the holding portion 110 after a safety check discharges the static electricity in the tweezers.

However, said tweezers are intended for surgical operation, but not for the purpose of holding thereby a minute object containing infinitesimal substances of which shapes are unrecognizable by the naked eyes or by the use of an optical microscope. In addition, since neither specific structure of connection between the connecting code 117 and the electrodes 111a and 111b, nor the inside details of the supporting portion 119 is disclosed, the mechanism is incomprehensible. In addition, the structure of said tweezers is extremely complex.

### SUMMARY OF THE INVENTION

Accordingly, taking account of those circumstances, the object of this invention is to provide tweezers with grounding wire that is effective to discharge the static electricity either from the human body or from the minute object, when it is held with the tweezers, and that is thus useful especially for holding a minute object containing an infinitesimal substance. By discharging static electricity from the human body, the infinitesimal substance can be prevented from being affected by static electricity. Furthermore, because static electricity is discharged when the minute object is held, the infinitesimal substance can be prevented from being destroyed or damaged by the transient current due to static electricity. In addition, in case that a resistor is incorporated, further moderation of the electrical effect is possible. Furthermore, another object of the present invention is to provide tweezers with grounding wire with simpler structure.

The first form of this invention is tweezers to which a grounding wire is connected so that the static electricity can be discharged when a human operates the tweezers. In this form, since the grounding wire is connected to the tweezers, static electricity from the human body or from the minute object itself can be discharged through the grounding wire when the minute object is grabbed by the tweezers. Particularly when the substance in the object is vulnerable to destruction either by static electricity or by the transient current due to movement of static electricity, or by the discharge of static electricity from a protruded portion, this substance can be prevented from being destroyed, thanks to discharging of static electricity forcibly and moderately. Particularly when the object that contains such a nanosubstance as a nanocarbon substance, very minute Si with a pointed end or very minute metallic grains, of which shapes cannot be observed by the naked eyes or an optical microscope, is grabbed by the tweezers, destruction of said infinitesimal substance by static electricity can be avoided because the static electricity is discharged through the grounding wire. In addition, said grounding wire can be connected to a grounding terminal on a receptacle in the room or a conductive building component leading to the ground, like a water pipe.

The second form of this invention is said tweezers to which a grounding wire is directly connected. In this form, since the grounding wire is directly connected to the tweezers, a simple structure is accomplished, while at the same time, it allows the static electricity from the human body and/or the object to be discharged directly through the grounding wire. Since the static electricity of the human body and/or the object can be directly discharged through the grounding wire, the substance in the object grabbed by the tweezers can be prevented from being destroyed.

The third form of this invention is said tweezers to which a grounding wire with a conductive detachable adaptor is connected. In this form, as a conductive detachable adaptor is provided on the end of the grounding wire, static electricity can be discharged through said adaptor to the grounding wire. When it is not necessary to discharge static electricity, the adaptor can be detached from the tweezers so that the tweezers may be used as ordinary tweezers.

The fourth form of this invention is said tweezers to which a grounding wire with a clip, in place of said conductive adaptor, is connected. In this form, since the conductive adaptor is a clip, the structure is simpler and this clip can be easily attached to, or detached from, the tweezers. The configuration of the clip can be a publicly known design. Also, the clip can be formed out of a metal, conductive plastic or other conductive material. Furthermore, once this clip is attached to the tweezers, it would not be dislodged from the tweezers, and thus it provides easy and secured grounding of the tweezers.

The fifth form of this invention is tweezers to which a grounding wire in either form of said first, second, third and fourth form is connected, and that is used to grab a minute object containing a infinitesimal substance of which shape is unrecognizable with the naked eyes or an optical microscope. In this form, the invented tweezers with grounding wire can be used for grabbing a minute object that contains an infinitesimal substance of which shape cannot be observed by the naked eyes or an optical microscope. In this occasion, by directly connecting the grounding wire to a receptacle with grounding feature, the static electricity can be easily eliminated. Especially, this invention is applicable to infinitesimal substances that are liable to be destroyed by static electricity. In case that a nanostructure as an infinitesimal substance is attached to said minute object, the former is liable to be destroyed by either static electricity, a transient current generated when static electricity moves, or discharge of static electricity through a protruded portion.

Though said infinitesimal substances are liable to be destroyed by static electricity, such static electricity destruction can be avoided if the minute object is grabbed by the tweezers with grounding wire, as it allows the static electricity from the human body and/or the minute object to be discharged through the grounding wire. These infinitesimal substances have such sizes that their shapes cannot be recognized by the naked eyes or an optical microscope, though they can be recognized by an electron microscope.

The sixth form of the invention is tweezers with grounding wire that is intended for said infinitesimal substance which is either a carbon nanosubstance or an extremely minute Si with a thin, pointed end or a metallic substance. In this form, when an infinitesimal substance made of a carbon nanosubstance is grabbed by the tweezers, with the static electricity from the human body or the minute object itself discharged through the grounding wire, the carbon nanosubstance, which is typical of nanosubstance, can be saved from destruction. In the carbon nanosubstances included are carbon nanotube, carbon nanocoil, fraren, amorphous carbon pillar, etc.

The seventh form of this invention is tweezers with grounding wire, wherein a resistor is connected either at the junction between said grounding wire and the tweezers, at the end of the grounding wire or at an intermediate position of the grounding wire. In this form, the resistor provided on the grounding wire causes the latter to consume the electric current by generating heat when the static electricity passes through the resistor R, so that the sparks due to static electricity can be avoided. Consequently, this form can be safely used in an explosive atmosphere without possibility of explosion ignited by the sparks.

### BRIEF DESCRIPTION OF THE DRAWINGS

FIG. 1 is a perspective view of tweezers with grounding wire showing the first embodiment of the present invention.

FIG. 2 is a perspective view of said tweezers with grounding wire which is connected to a grounding terminal in a room.

FIG. 3 is a perspective view of said tweezers with grounding wire connected to a water faucet.

FIG. 4 is a perspective view of a minute object containing a infinitesimal substance in a case.

FIG. 5 is a perspective view of a person pressing his or her hands on an iron plate to discharge static electricity out of human body.

FIG. 6 is a perspective view of a minute object containing an infinitesimal substance in a case just before it is grabbed with said tweezers with grounding wire.

FIG. 7 is a perspective view of a minute object containing an infinitesimal substance grabbed with said tweezers with grounding wire.

FIG. 8 is a perspective view of a minute object containing an infinitesimal substance in a case grabbed and lifted with said tweezers with grounding wire.

FIG. 9 is a perspective view of said tweezers and a second embodiment of a grounding wire to which a clip is attached before it is attached to the tweezers.

FIG. 10 is a perspective view of said tweezers with grounding wire attached to the tweezers by way of said clip.

FIG. 11 is a perspective view of said tweezers with a grounding wire grabbing a minute object containing an infinitesimal substance.

FIG. 12 is a perspective view of said tweezers with a grounding wire of the third embodiment.

FIG. 13 is a perspective view of the conventional tweezers.

### DETAILED DESCRIPTION OF THE INVENTION

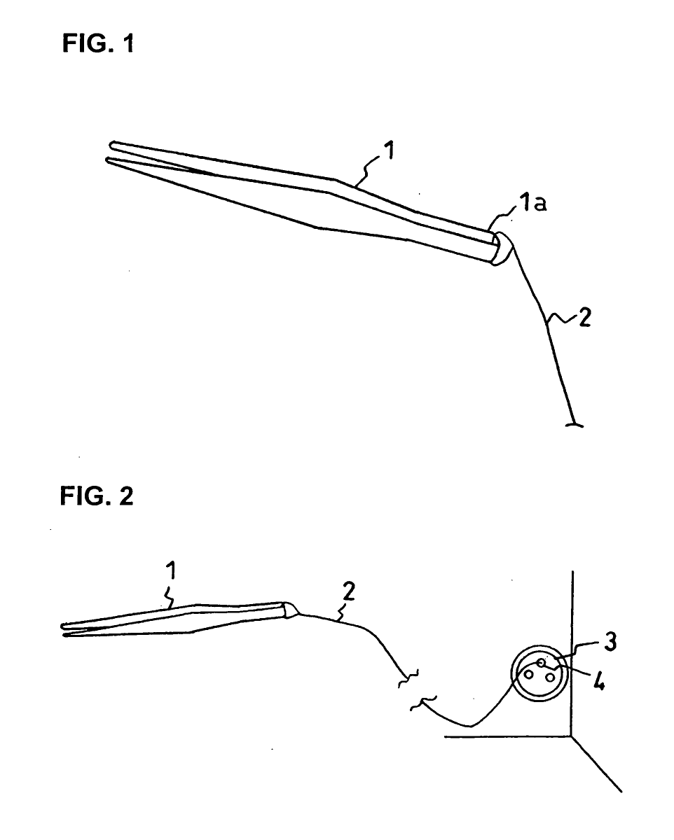

Embodiments of the tweezers with grounding wire of the present invention will be described in detail below with reference to the accompanying FIG. 1 through FIG. 11.

FIG. 1 shows a perspective view of the tweezers with grounding wire representing the first embodiment of the present invention. As shown in FIG. 1, the grounding wire 2 is connected to, or wound around, the tweezers 1 at the back end of the tweezers where it bends. When a person holds the tweezers 1, the static electricity of the human body will be discharged to the grounding wire 2 through the tweezers 1.

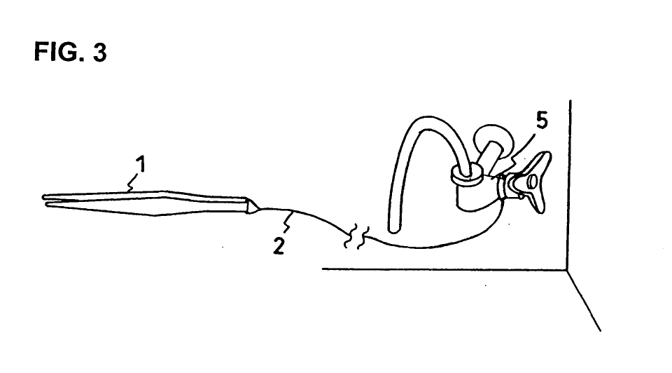

FIG. 2 shows a perspective view of said tweezers with grounding wire which is connected to a grounding terminal of a receptacle. As shown in FIG. 2, the grounding wire 2 connected to the tweezers 1 is connected to the grounding terminal 4 on the receptacle 3. Static electricity of a person who holds the tweezers 1 will flow through the grounding wire 2 to the grounding terminal 4 of the receptacle 3.

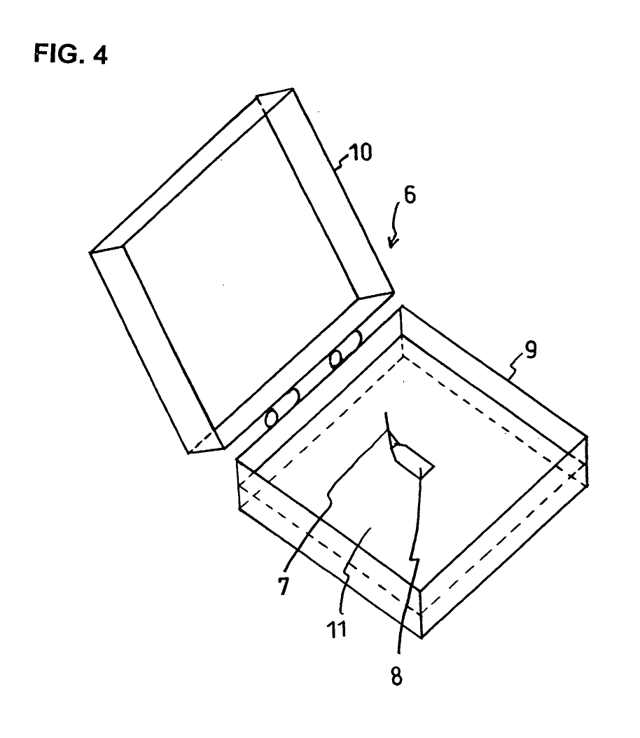

FIG. 3 is a perspective view of the tweezers with grounding wire which is connected to a water faucet. As shown in FIG. 3, in this example, the grounding wire 2 connected to the tweezers 1 is connected to a water faucet 5 in the form of winding around it. The static electricity of a person who holds the tweezers 1 will flow from the tweezers 1 to the grounding wire 2, further to the water faucet 5, and then eventually to the ground.

FIG. 4 shows a perspective view of an infinitesimal substance and a minute object containing it, as stored in a case. The case 6 is a container to store the infinitesimal substance 7 and the minute object 8 that contains it. This case 6 is comprised of a conductive main body 9 and a conductive lid 10 which will close or open the opening part of the main body 9. Furthermore, a stabilizing pedestal 11 made of conductive gel or the like is provided in the main body 9 of the case.

The infinitesimal substance 7 and the minute object 8 containing the former are placed stably on the conductive pedestal 11 with adhesiveness on its surface. As the case 6 is exclusively comprised of conductive components, the case is protected from static electricity. Thus, without static electricity on the minute object 8, the infinitesimal substance 7 is free from damage due to static electricity, rendering the case 6 safe.

The infinitesimal substance 7 includes, for example, substances in a size range of 1 nm˜100 nm, within which a carbon nanosubstances and the like are included. An object that incorporates said infinitesimal substance, is referred to as minute object, including, for instance, nanosubstance products and semi-conductor micro-products such as semi-conductor cantilever. The carbon nanosubstances include carbon nanotube, carbon nanocoil, fraren and amorphous carbon pillar. Also, the effects of static electricity include the transient current when the static electricity moves as well as discharge of static electricity from a protruded portion. This infinitesimal substance 7, generally having a size close to or smaller than the wavelength of light, is unobservable by the naked eyes or optical microscope, though it can be observed by an electron microscope.

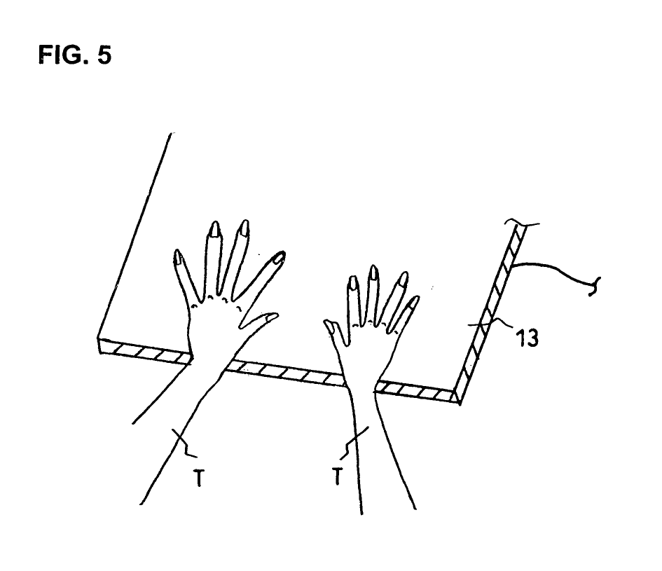

FIG. 5 shows a perspective view of a person pressing his or her hands on a metal plate to discharge static electricity from his or her body. As shown in FIG. 5, a person can press his or her hands T on a metal plate 12 before touching the tweezers 1, to discharge static electricity out of his or her body. Thus, if the static electricity in human body is discharged to the metal plate 12, virtually no static electricity will remain in the human body.

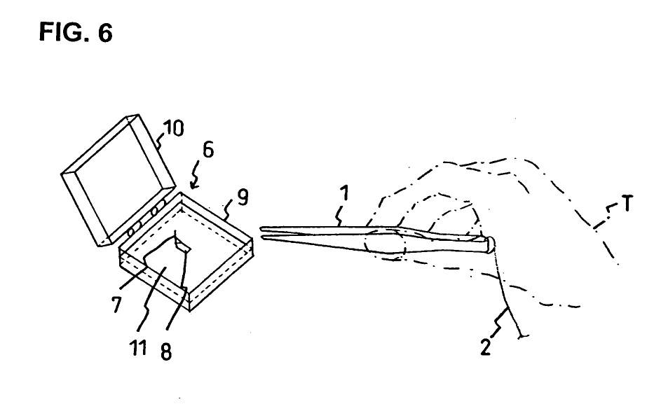

FIG. 6 shows a perspective view of the tweezers with grounding wire just about to hold a minute object stored in a case. Even if static electricity has been discharged from the human body in the manner as shown in FIG. 5, said human body may accumulate static electricity due to friction with clothing he or she wears. In order to discharge this remnant static electricity completely, the tweezers 1 are provided with a grounding wire 2, as shown in FIG. 6, whereby the static electricity is discharged when the person holds the tweezers 1. As a consequence, in the condition shown in FIG. 6, no static electricity remains in the human body. Subsequently, the tweezers 1 is moved closer to the minute object 8 containing a infinitesimal substance 7 in the case 6.

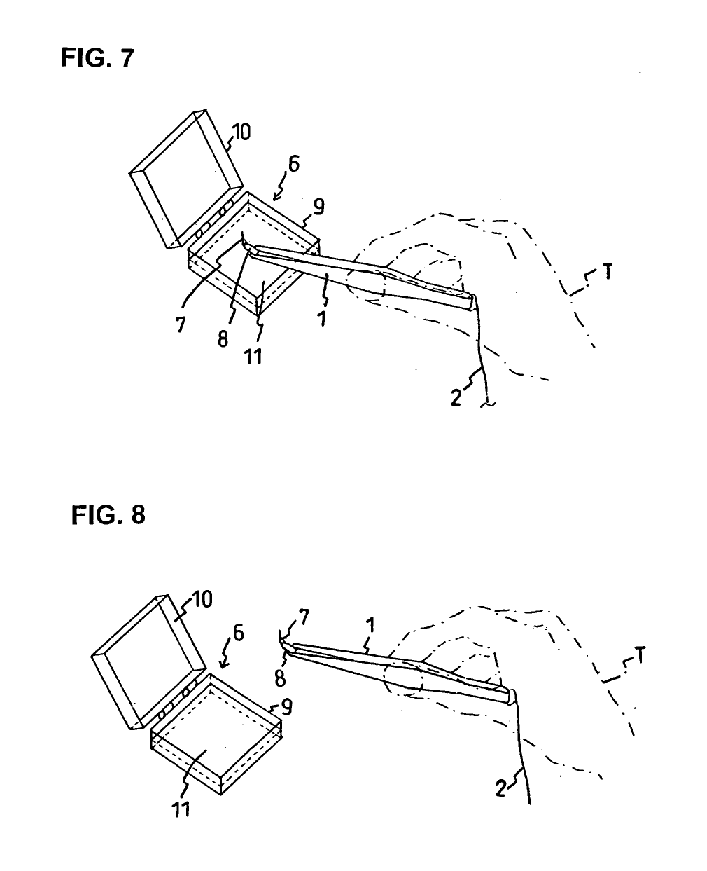

FIG. 7 shows a perspective view of the tweezers holding the minute object 8 stored in the case. As shown in FIG. 7, a person holds a minute object 8 containing a infinitesimal substance 7 with the tweezers 1 at the tip end. At this point of time, because static electricity of a human body has already been discharged through the tweezers 1 and further through the grounding wire 2, the minute object 8 and the infinitesimal substance 7 contained therein are kept free from the action of static electricity, and hence intact from destruction or damage thereby. In addition, static electricity in the minute object can also be discharged when it is grabbed by said tweezers.

FIG. 8 shows a perspective view of said tweezers with grounding wire holding and lifting a minute object containing an infinitesimal substance from a case. As shown in FIG. 8, the minute object 8 containing an infinitesimal substance 7 is brought out of the case 6 as held by the tweezers 1. Static electricity has already been discharged through the tweezers 1 and the grounding wire 2. Therefore, without any static electricity remaining in the human body, the minute object 8 and the infinitesimal substance 7 therein are free from destruction or damage. Thus, the minute object 8 containing the infinitesimal substance 7 can be safely brought out of the case 6 as grabbed with the tweezers 1. In addition, static electricity that is generated when the minute object 8 is taken away from the gel is also discharged, and thus the minute object 8 and the infinitesimal substance 7 therein are kept intact.

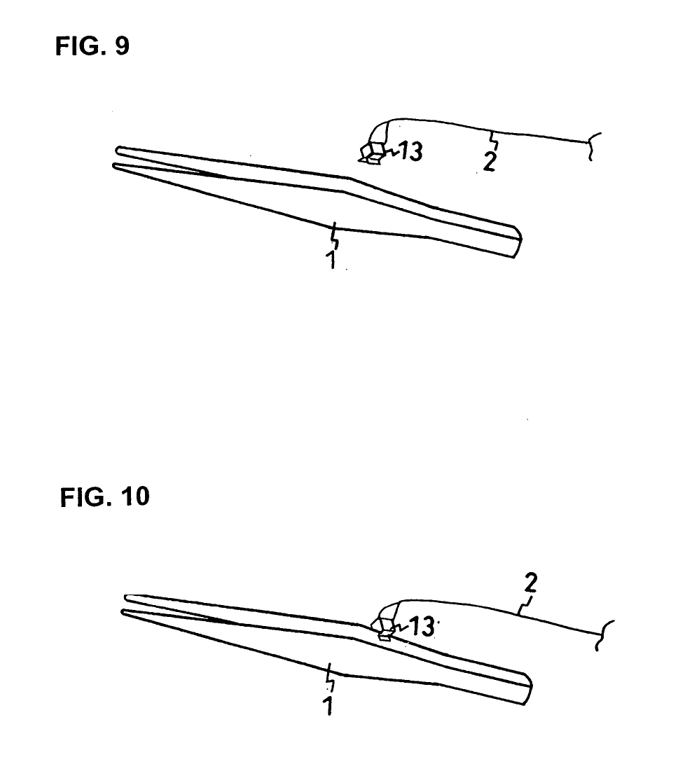

FIG. 9 shows a perspective view of the tweezers with a grounding wire of the second embodiment wherein the clip on the end of the grounding wire is about to be attached to the tweezers. The tweezers with grounding wire in the second embodiment, as shown in FIG. 9 is characterized in that a clip 13 is attached to the end of the grounding wire 2. This clip 13 can be readily attached to, or detached from, the tweezers 1.

FIG. 10 shows a perspective view of the tweezers with grounding wire wherein the clip connected to the end of the grounding wire has been attached to the tweezers. As shown in FIG. 10, the clip 13 at the end of the grounding wire 2 is attached to the tweezers 1 in such manner that it pinches the top end of the tweezers 1. When a person holds the tweezers 1, the static electricity of his or her body is discharged from the tweezers 1 through the clip 13 and the grounding wire 2.

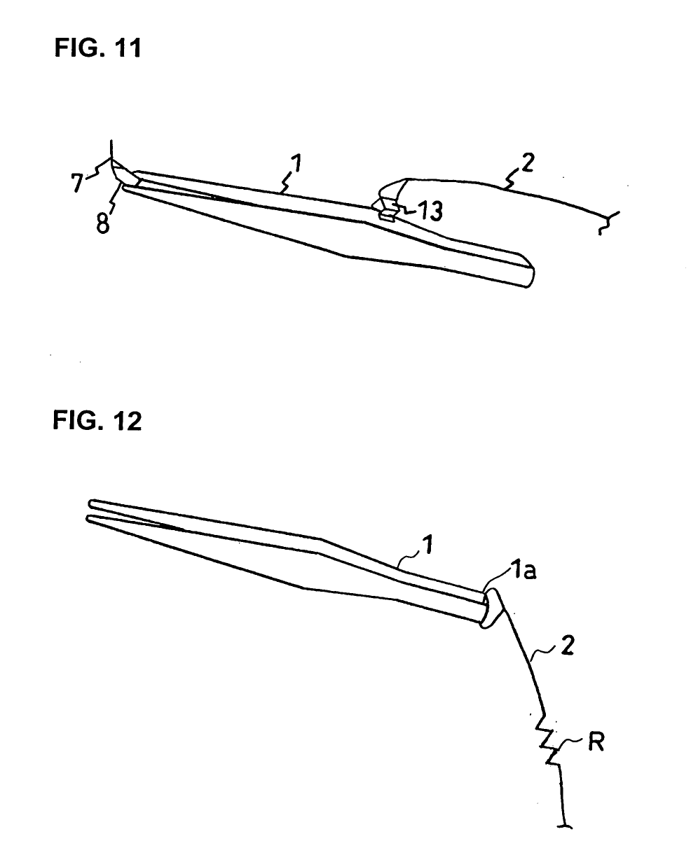

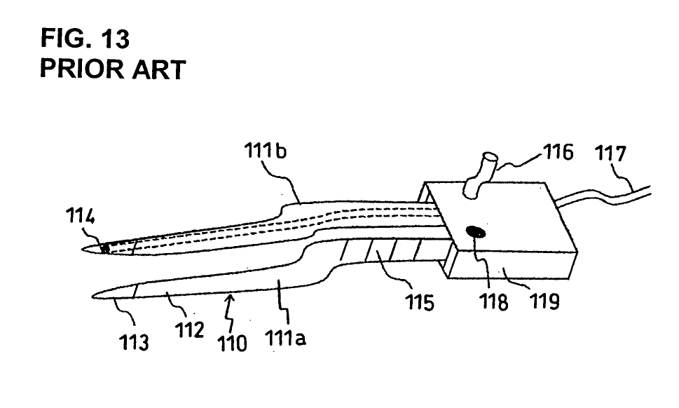

FIG. 11 shows a perspective view of the tweezers with grounding wire grabbing a minute object containing a infinitesimal substance. As shown in FIG. 11, the tweezers 1 are grabbed and used to hold and manipulate a minute object 8 containing the infinitesimal substance 7. At this point of time, because static electricity in the human body has been discharged from the tweezers 1 through the clip 13, to the grounding wire 2, the minute object 8 and the infinitesimal substance 7 are free from destruction or damage.

In this third embodiment, as the clip 13 on the end of the grounding wire 2 can be readily attached to, or detached from, the tweezers 1, it has a merit in that with clip 13 detached from the tweezers 1, it can be used as an ordinary tweezers.

FIG. 12 shows a perspective view of tweezers with grounding wire in the third embodiment. As shown in FIG. 12, this third embodiment of the tweezers with grounding wire is provided with a resistor R in the middle of the grounding wire 2 connected to the tweezers 1. Thanks to this resistor R connected to the grounding wire 2, static electricity causes, when it passes through this resistor R heat to be generated, consuming electric current rapidly, and thus preventing sparks from occurring. Thus, this embodiment, being free from sparks, is kept safe even in an explosive ambient atmosphere. It goes without saying that this resistor R can be provided alternatively either at the connection between the tweezers 1 and grounding wire 2, or at either end of the grounding wire 2. Also, it goes without saying that this resistor R may be applied to the second embodiment of the tweezers with grounding wire.

It is needless to say that the present invention is not limited to the above-described embodiments; and various modifications and design changes, etc. within this limits that involve no departure from the technical spirit of the present invention are included in the scope of the present invention.

### INDUSTRIAL APPLICABILITY

The tweezers with a grounding wire according to the present invention is useful not only for grabbing a minute object containing a infinitesimal substance of which shape cannot be recognized with the naked eyes or an optical microscope, but also for grabbing other substances that are liable to be destroyed or damaged by static electricity.

1. A tweezers with grounding wire characterized in that said tweezers are provided with a grounding wire to discharge static electricity from a human body or an object pinched by said tweezers when said tweezers are manipulated by said human.

2. The tweezers with grounding wire according to claim 1, wherein said grounding wire is directly connected to said tweezers.

3. The tweezers with grounding wire according to claim 1, wherein a conductive adaptor which is detachable from said tweezers is provided at an end of said grounding wire.

4. The tweezers with grounding wire according to claim 3, wherein said conductive adaptor is a clip connected to said end of said grounding wire.

5. The tweezers with grounding wire according to claim 1, 2, 3 or 4, wherein said tweezers are used for grabbing a minute object containing an infinitesimal substance of which shape cannot be recognized by naked eyes or an optical microscope.

6. The tweezers with grounding wire according to claim 5, wherein said infinitesimal substance is a carbon nanosubstance.

7. The tweezers with grounding wire according to any one of claims 1 to 4, wherein a resistor is connected between said grounding wire and said tweezers, at an end of, or at midway of said grounding wire.

8. The tweezers with grounding wire according to claim 5, wherein a resistor is connected between said grounding wire and said tweezers, at an end of, or at midway of said grounding wire.

9. The tweezers with grounding wire according to claim 6, wherein a resistor is connected between said grounding wire and said tweezers, at an end of, or at midway of said grounding wire.
